(19) United States
(12) Patent Application Publication
(10) Pub. No.: US 2024/0207717 A1
(43) Pub. Date: Jun. 27, 2024

(54) LOTTERY TICKETS HAVING DIFFERENT SYMBOL SETS WITH ASSOCIATED DIFFERENT SEQUENTIAL PAYOUT AMOUNTS

(71) Applicant: IGT GLOBAL SOLUTIONS CORPORATION, Providence, RI (US)

(72) Inventors: Anthony Lucci, North Kingstown, RI (US); Jeffrey Schertzer, Valrico, FL (US)

(21) Appl. No.: 18/085,848

(22) Filed: Dec. 21, 2022

(51) Int. Cl. A63F 3/06; G07F 17/32

(52) U.S. Cl. CPC A63F 3/0665; A63F 3/0655; G07F 17/329

(57) ABSTRACT

Lottery tickets and lottery gaming systems and methods providing such lottery tickets, wherein the lottery tickets each have a connected symbol set path feature including a plurality of connected symbol sets along a bonus award path, a plurality of player symbols, and potential awards that can be won based on the symbol sets and the connected symbol sets along the bonus award path and the player symbols.

### BACKGROUND

The present disclosure relates to lottery tickets having different symbol sets associated with different sequential payout amounts.

Instant lottery tickets are widely available. Instant lottery tickets may include predetermined win or lose symbols under one or more covers such as a scratch-off-coating (“SOC”). The covers are used to ensure that the lottery ticket has not been previously played. Millions of different types of instant lottery tickets are produced and sold every year.

### BRIEF SUMMARY

In various embodiments, the present disclosure provides a lottery ticket including: a base; a plurality of different symbol sets on the base, wherein each of the symbol sets include a plurality of different symbols; a plurality of different sequential ascending payout amounts on the base and respectively associated with the plurality of different symbol sets; a plurality of different player symbols on the base; a first removable cover on the base covering the plurality of player symbols; and a second removable cover on the base covering the plurality of different sequential ascending payout amounts.

In various other embodiments, the present disclosure provides a plurality of lottery tickets for a same lottery game. The plurality of lottery tickets include: a first lottery ticket including: a base; a plurality of different symbol sets on the base, wherein each of the symbol sets include a plurality of different symbols; a plurality of different sequential ascending payout amounts on the base and respectively associated with the plurality of different symbol sets; a plurality of different player symbols on the base; a first removable cover on the base covering the plurality of player symbols; and a second removable cover on the base covering the plurality of different sequential ascending payout amounts. The plurality of lottery tickets also include: a second lottery ticket including: a base; a plurality of different symbol sets on the base, wherein each of the symbol sets include a plurality of different symbols; a plurality of different sequential ascending payout amounts on the base and respectively associated with the plurality of different symbol sets on the base; a plurality of different player symbols on the base; a first removable cover on the base covering the plurality of player symbols; and a second removable cover on the base covering the plurality of different sequential ascending payout amounts. The plurality of different symbol sets of the first lottery ticket is the same as the plurality of different symbol sets of the second lottery ticket, and the plurality of different sequential ascending payout amounts of the second lottery ticket are different than the different sequential ascending payout amounts of the first lottery ticket.

In various other embodiments, the present disclosure provides a system including a processor and a memory device that stores a plurality of instructions, that when executed by the processor, cause the processor to cause a plurality of lottery tickets to be created. The plurality of lottery tickets include a first lottery ticket including: a base; a plurality of different symbol sets on the base, wherein each of the symbol sets include a plurality of different symbols; a plurality of different sequential ascending payout amounts on the base and respectively associated with the plurality of different symbol sets; a plurality of different player symbols on the base; a first removable cover on the base covering the plurality of player symbols; and a second removable cover on the base covering the plurality of different sequential ascending payout amounts. The plurality of lottery tickets include a second lottery ticket including: a base; a plurality of different symbol sets on the base, wherein each of the symbol sets include a plurality of different symbols; a plurality of different sequential ascending payout amounts on the base and respectively associated with the plurality of different symbol sets on the base; a plurality of different player symbols on the base; a first removable cover on the base covering the plurality of player symbols; and a second removable cover on the base covering the plurality of different sequential ascending payout amounts. The plurality of different symbol sets of the first lottery ticket is the same as the plurality of different symbol sets of the second lottery ticket. The plurality of different sequential ascending payout amounts of the second lottery ticket are different than the different sequential ascending payout amounts of the first lottery ticket.

Additional features are described in, and will be apparent from, the following Detailed Description and the figures.

### BRIEF DESCRIPTION OF THE SEVERAL VIEWS OF THE DRAWINGS

FIG. 1A is a front view of an example lottery ticket of one example embodiment of the present disclosure that includes different symbol sets associated with different sequential ascending payout amounts and showing the lottery ticket with the SOCs in place covering the player symbols and the payout amounts.

FIG. 1B is a front view of the example lottery ticket of FIG. 1 and showing the SOCs removed from covering the player symbols and from covering the payout amounts.

FIG. 2 is a front view of an example table showing payout amounts that indicate awards for example lottery tickets of an example lottery game of the present disclosure.

FIG. 3 is a flowchart of an example method of providing the example lottery ticket of FIG. 1 in accordance with one example embodiment of the present disclosure.

FIG. 4 shows an example lottery gaming system of one example embodiment of the present disclosure.

### DETAILED DESCRIPTION

In various embodiments, the present disclosure relates to lottery tickets for a lottery game wherein each lottery ticket has a plurality of different symbol sets associated with sequential payout amounts, and lottery gaming systems and methods of operating lottery gaming systems that create, provide, and process such lottery tickets for such lottery game. In various embodiments, the sequential payout amounts are sequential ascending payout amounts. In various other embodiments, the sequential payout amounts are sequential descending payout amounts. For brevity, sequential ascending payout amounts are used as the primary example herein to describe the present disclosure, but it should be appreciated that such example is not meant to limit the present disclosure.

In various embodiments of the present disclosure, each of a plurality of different lottery tickets for a lottery game that is created and provided by the lottery gaming system includes: a base (such as but not limited to a paper substrate); a plurality of different symbol sets on the base; a plurality of player symbols on the base; and a plurality of different sequential ascending payout amounts (such as in a paytable or otherwise) on the base that respectively indicate the potential awards that can be won based on each of the different symbol sets and the player symbols for that specific lottery ticket. For each lottery ticket, the respective plurality of different ascending payout amounts represent a plurality of potential awards associated with that specific lottery ticket, wherein for each such lottery ticket, awards corresponding to zero, one, a plurality, or all of such payout amounts can be won based on the respective symbol sets completed based on the player symbols of that lottery ticket. For two or more of the lottery tickets for a single lottery game, the plurality of different ascending payout amounts respectively associated with the different symbol sets are different, and thus two or more of the lottery tickets with the same completed symbol sets can result in different awards for those lottery tickets. In various embodiments, the lottery tickets are physical lottery tickets and in various other embodiments, the lottery ticket are virtual lottery tickets.

In various embodiments, the symbol sets are card hands, and the player symbols are cards (such as cards from a standard deck of playing cards). In various such embodiments, each lottery ticket for a lottery game provided by the lottery gaming system includes: a base; a plurality of different card hands on the base; a plurality of player cards on the base; and a plurality of different sequential ascending payout amounts (corresponding to a plurality of different sequential ascending awards) respectively associated with the card hands on the base (and thus that lottery ticket). In various such embodiments, for each lottery ticket, the different sequential ascending payout amounts indicate awards that could be won for that lottery ticket based on which cards hands are completed which is based on the player cards on that lottery ticket. In various such embodiments, different lottery tickets for the same lottery game will have different sequential ascending payout amounts (and thus different sequential ascending winnable awards) associated with the different card hands.

In various embodiments, for each lottery ticket, the card hands of the lottery ticket are arranged in a plurality of row or a plurality of columns. In various embodiments, the card hands are arranged in a sequence order and the associated different sequential ascending payout amounts are selected and arranged in a corresponding plurality of row or a plurality of columns. It should be appreciated that the card hands and the different sequential ascending payout amounts can be alternatively shaped, sized, and otherwise configured in accordance with the present disclosure.

In various embodiments, one or more non-see-through SOC cover(s) the player symbols (such as the player cards) on the base, and the player must remove such SOCs to visually see the different player symbols (such as the player cards). Thus, when a player purchases such a lottery ticket, the player will not know the actual player symbols for that lottery ticket.

In various embodiments, the different sequential ascending payout amounts respectively associated with the symbol sets (such as the card hands) on the base are also covered with one or more non-see-through SOCs, and the player must remove such SOCs to visually see the different sequential ascending payout amounts. Thus, in such embodiments, when a player purchases such a lottery ticket, the player would not know the actual different sequential ascending payout amounts respectively associated with the different symbol sets of that lottery ticket. It should further be appreciated that unlike many lottery games where each lottery ticket has the same potential payout amounts (and thus the same potential awards), the present disclosure contemplates that different lottery tickets for the same lottery game have different sequential ascending payout amounts respectively associated with the different symbol sets of those lottery tickets. Thus, in various embodiments, a single lottery game can include: (1) multiple different pluralities of lottery tickets for the lottery game having the same set of different symbol sets and the same sets of different sequential ascending payout amounts; (2) multiple different pluralities of lottery tickets for the lottery game having the different sets of different symbol sets and the same sets of different sequential ascending payout amounts; (3) multiple different pluralities of lottery tickets for the lottery game having the same set of different symbol sets and different sets of different sequential ascending payout amounts; and (4) multiple different pluralities of lottery tickets for the lottery game having different sets of different symbol sets and different sets of different sequential ascending payout amounts. In various embodiments, the symbol sets can be different in that they include different categories of symbol sets and/or in that they include different symbols (such as different cards) that form two or more of the respective symbol sets.

In various embodiments, the symbol sets (such as the card hands) on the base can also be covered with one or more non-see-through SOCs that initially cover the symbol sets, and that requires the player to remove such SOCs to visually see the symbol sets. Thus, when a player purchases such a lottery ticket, the player may not know the actual symbol sets of that lottery ticket.

In various embodiments, the symbol sets (such as the card hands) on the base can be covered with a see-through SOC that enables a player to see the symbol sets (such as the card hands) on the base under the see-through SOC and to remove such SOC for each of the symbols of each of the symbol sets on the base that matches one of the player symbols on the base to enable the player to keep track of or visually see the symbol sets (such as the card hand) that are uncompleted, partially completed, and fully completed on the base in view of the revealed player symbols (such as the player cards) as those player symbols are revealed by the player removing the SOC covering the player symbols. In the example embodiments discussed herein, the see-through SOC over the symbol sets (such as the card hands) on the base is not employed for brevity and simplicity.

In various embodiments, the symbol sets (such as the card hands) of a lottery ticket each include one or more shared symbols (such as shared cards) with one or more of the other symbol sets of that lottery ticket.

In various embodiments, the symbol sets (such as the card hands) of a lottery ticket each include one or more unshared symbols (such as shared cards) with one or more of the other symbol sets of that lottery ticket.

In various embodiments, the lottery gaming system and method pick the symbol sets (such as the card hands) for each lottery ticket based on the desired actual award(s) for that lottery ticket.

In various embodiments, the lottery gaming system and method pick the symbols (such as the cards) for each of symbol sets (such as the card hands) for each lottery ticket based on the desired actual award(s) for that lottery ticket.

In various embodiments, for each lottery ticket, the plurality of player symbols (such as player cards) includes any suitable quantity of player symbols (such as cards). In various embodiments, the plurality of player symbols (such as player cards) are randomly determined for each lottery ticket by the lottery gaming system. In various embodiments, the plurality of player symbols (such as player cards) are otherwise suitably determined. In various embodiments, the lottery gaming system and method pick the player symbols (such as the player cards) for each lottery ticket based on the desired actual award(s) for that lottery ticket.

The quantity of the player symbols (such as player cards) for each lottery ticket can vary or be the same for each lottery ticket of a lottery game in accordance with the present disclosure. The quantity of the player symbols (such as player cards) on the lottery tickets can vary based on the wager on or purchase price for the lottery ticket in various embodiments. The quantity of the player symbols (such as player cards) on the lottery tickets can vary based on one or more other or additional factors for the lottery ticket in various embodiments. In various embodiments, the lottery gaming system and method pick the quantity of player symbols (such as the player cards) for each lottery ticket based on the desired actual award(s) for that lottery ticket.

In various embodiments, for each lottery ticket for a lottery game, the quantity of symbol sets (such as card hands) includes any suitable quantity of symbol sets (such as card hands). The quantity of the symbol sets (such as card hands) for each lottery ticket of a lottery game can vary or be the same for each lottery ticket of the lottery game in accordance with the present disclosure. The quantity of the symbol sets (such as card hands) on the lottery tickets can vary based on the wager on or purchase price for the lottery ticket in various embodiments. The quantity of the symbol sets (such as card hands) on the lottery tickets can vary based on one or more other or additional factors for the lottery ticket in various embodiments. In various embodiments, the plurality of symbol sets (such as card hands) are randomly determined for each lottery ticket by the lottery gaming system. In various embodiments, the plurality of symbol sets (such as card hands) are otherwise suitably determined.

In various embodiments, each lottery ticket provides multiple possible ways for a player of the lottery ticket to potentially win awards (even though any particular lottery ticket can be associated with zero awards, only one award, a plurality of but less than a maximum quantity of potential awards, or the maximum quantity of potential awards). The player can win one or more awards of via the revealing of the plurality of the player symbols (such as player cards) on the base and a determination of whether any combinations of the player symbols (such as player cards) form any complete symbol sets (such as complete card hands) on the base. For this award determination, the player can win an award for each of the completed symbol sets (such as the each completed card hand) on the base formed by combinations of the player symbols (such as the player cards). Different completed symbol sets (such as the different completed card hands) on the base are each respectively associated with a different one of the different sequential ascending payout amounts (and thus different associated awards) for that lottery ticket, as explained above. In various example embodiments, each completed symbol set (such as each completed card hand) has an associated payout amount (and thus an associated award). In an alternative example embodiment, specific groups of two or more of the completed symbol sets (such as completed card hands) can have different associated payout amounts (such as awards).

In various embodiments, the payout amounts (and thus the awards) for one or more of the completed symbol sets (such as completed card hands) are based at least in part on a quantity of symbols of that completed symbol set (such as that completed card hand). For example, completed symbol sets (such as completed card hands) with a greater quantity of symbols (such as player cards) can have higher awards associated with such completed symbol sets (such as completed card hand) than with a smaller quantity of player symbols (such as player cards). In various other embodiments, the payout amounts (and thus the awards) for one or more of the completed symbol sets (such as completed card hands) is independent of the quantity of symbols of that completed symbol set (such as that completed card hand).

In various embodiments, the payout amounts (and thus the awards) for one or more of the completed symbol sets (such as completed card hands) are at least partly based on the probability of one or more symbols of that completed symbol set (such as that completed card) being a player symbol (such as a player card). For example, completed symbol sets (such as completed card hand) with a lower probability of occurring can have higher awards associated with such completed symbol sets (such as completed card hand) than with completed symbol sets (such as completed card hands) with a higher probability of occurring.

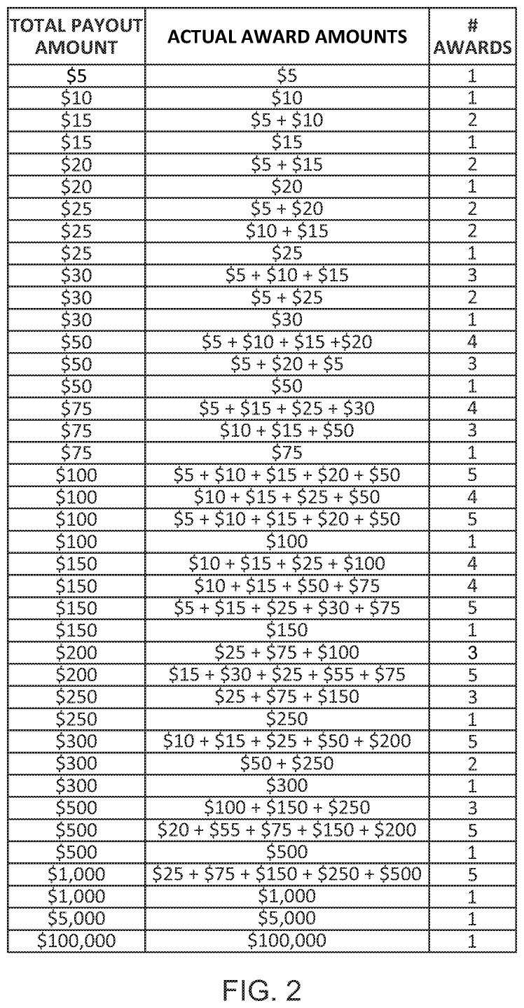

In various embodiments, the payout amounts (and thus as the awards) for the completed symbol sets (such as completed card hands) are at least partly based on a payout award table. For example, the payout award table shown in FIG. 2 can be employed to determine the actual payout amounts (and this the awards) for a lottery ticket that will actually be paid to the player of that lottery ticket from all of the different sequential ascending payout amounts for that lottery ticket. The table shows example different: (1) total payout amounts in the column on the left; (2) individual actual payout amounts (and this the awards) for each of the symbol set (such as each of the card hands) in the center column; and (3) the quantity of awards corresponding to each of the total payout amount in the column on the right. In this example, each of the individual actual payout amounts (and thus the awards) for each of the symbol sets (such as each of the card hands) in the center column are the payout amounts of the different sequential ascending payout amounts that will actually be paid for that specific lottery ticket. For example, if a lottery ticket includes five card hands and the different sequential ascending payout amounts for those card hands are $50, $100, $150, $1000, and $5000, and the selected individual actual payout amount for that lottery ticket is $5000, then the lottery gaming system will arrange the card hands and player cards such that only the last card hand associated with the $5000 payout amount will be a completed card hand for that lottery ticket. In various embodiments, (1) the lottery gaming system (for creating the lottery tickets for a lottery game) first selects the total payout amount for each lottery ticket for the lottery game, (2) then the lottery gaming system selects the respective individual different sequential ascending payout amounts for each lottery ticket and which ones, if any, of those payout amounts will be actually won for each lottery ticket, and (3) then the lottery gaming system selects the cards for the card hands and the cards for the player cards based on the determined award(s), if any, to be won for each lottery ticket.

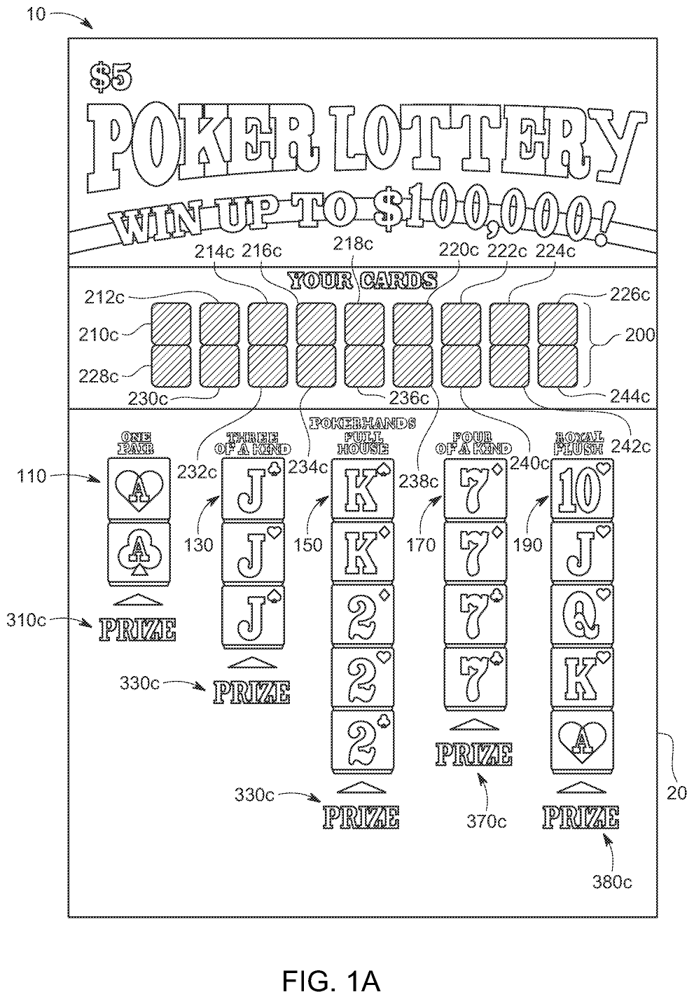

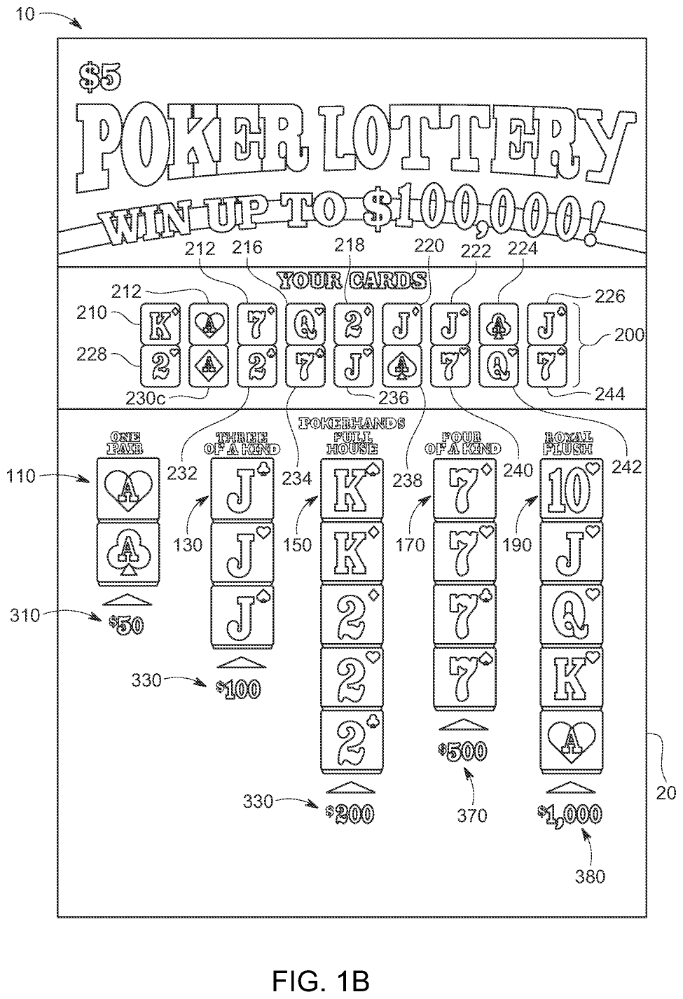

For purposes of further explaining an example embodiment of the present disclosure in conjunction with the example lottery ticket of FIGS. 1 and 2, each of the player symbols of the lottery ticket can be any of the 52 cards of a conventional playing card deck (on a non-repeated non-duplicated basis), and the different symbol set categories (card hand categories) that can be formed by such cards such as follows:

| | | Example |
|---|---|---|
| | | Variable |
| | | Payout |
| Card Hand | | Amount |
| Categories | Example Card Hands | Ranges |
| Royal Flush | A [symbol] K [symbol] Q [symbol] J [symbol] 10 [symbol] | $200 to |
| | | $100,000 |
| Four of a Kind | J [symbol] J♥ J♦ J [symbol] 3 [symbol] | $20 to $250 |
| Full House | A♥ A♦ A [symbol] 6♦ 6 [symbol] | $15 to $150 |
| Three of a Kind | Q [symbol] Q♥ Q♦ 6♦ 2 [symbol] | $10 to $75 |
| One Pair | K♦ K [symbol] 8 [symbol] 7 [symbol] 2♥ | $5 to $25 |

While the card hand categories are listed from highest to lowest payout amount, the payout amounts for each card hand category are not static such as in various known lottery games. Additionally, in various embodiments, the card hand categories can vary, and for instance can include one or more other card hand categories such as a straight flush, a flush, a straight, or two pair in addition to or in place of any one or more of the above example card hands.

FIGS. 1 and 2 illustrate an example lottery ticket 10 for a lottery game of one example embodiment of the present disclosure that can be provided by a lottery gaming system of the present disclosure and purchased by a player. In this example embodiment, the lottery ticket 10 includes a base 20 (in the form of a substrate), a plurality of different card hands 110, 130, 150, 170, and 190 formed (such as printed) on the base 20, a plurality of different player cards 210, 212, 214, 216, 218, 220, 222, 224, 226, 228, 230, 232, 234, 236, 238, 240, 242, and 244 (collectively 200) formed (such as printed) on the base 20, a plurality of different payout amounts 310, 330, 350, 370, and 390 formed (as printed) on the base 20 and respectfully associated with the plurality of different card hands 110, 130, 150, 170, and 190. In this example embodiment, all of the lottery tickets for this lottery game include the same card hands but one or more of the individual cards of those card hands vary.

The lottery ticket 10 further includes scratch-off coatings 210C, 212C, 214C, 216C, 218C, 220C, 222C, 224C, 226C, 228C, 230C, 232C, 234C, 236C, 238C, 240C, 242C, and 244C (shown in FIG. 1 and indicated by the cross-hatching in this example) applied on the base 20 and initially covering each of the player cards 200. FIG. 2 shows the lottery ticket 10 with the scratch-off coatings 210C, 212C, 214C, 216C, 218C, 220C, 222C, 224C, 226C, 228C, 230C, 232C, 234C, 236C, 238C, 240C, 242C, and 244C removed from the player letters 200.

The lottery ticket 10 further includes scratch-off coatings 310C, 330C, 350C, 370C, and 390C (shown in FIG. 1 and indicated by the PRIZE indications in this example) applied on the base 20 and initially covering each of the payout amounts 310, 330, 350, 370, and 390. FIG. 2 shows the lottery ticket 10 with the scratch-off coatings 310C, 330C, 350C, 370C, and 390C removed from the different sequential ascending payout amount 200. In this example, the payout amount 310 is $50, the payout amount 330 is $100, the payout amount 350 is $200, the payout amount 370 is $500, and the payout amount 390 is $1000. These different sequential ascending payout amounts are respectfully displayed in association with the plurality of different card hands 110, 130, 150, 170, and 190 (and thus each of these respective different card hand categories). These different sequential ascending payout amounts are specifically selected for this lottery ticket by the lottery gaming system. These different sequential ascending payout amounts respectively associated with these different card hand categories and thus these card hands can vary as explained above. For example: (1) for another lottery ticket of the same lottery game, the different sequential ascending payout amounts associated with the same card hands could be $50, $100, $200, $500, and $1000; (2) for another lottery ticket of the same lottery game, the different sequential ascending payout amounts associated with the same card hands could be $100, $500, $1000, $5000, and $50,000; (3) for another lottery ticket of the same lottery game, the different sequential ascending payout amounts associated with the same card hands could be $50, $100, $200, $5000, and $100,000; and (4) for another lottery ticket of the same lottery game, the different sequential ascending payout amounts associated with the same card hands could be $500, $1000, $2000, $5000, and $10000. Thus, it should be appreciated that for the same lottery game, the available different sequential ascending payout amounts can be different, and that for each lottery ticket, zero, one, or a plurality of those available different sequential ascending payout amounts for that lottery ticket can be paid to the player for that lottery ticket.

In the example lottery ticket 10 shown in FIGS. 1 and 2, the player cards are: K♦, A♥, 7♦, Q♥, 2♦, J♦, J [symbol] , A [symbol] , J [symbol] , 2♥, A♦, 2 [symbol] , 7 [symbol] , J♥, A [symbol] , 7♥, Q♥, and 7 [symbol] .

In this example, the completed card hands based on these player cards are: (1) the one pair card hand including the A♥ and the A [symbol] ; (2) the three of a kind card hand including the J [symbol] , the J♥, and the J [symbol] ; and (3) the four of a kind hand including the 7♦, the 7♥, the 7 [symbol] , and the 7 [symbol] . Each of these card hands are one of the different card hand categories, and the payout amounts associated with such card hand categories and thus such specific card hands can be provided to the player for this lottery ticket.

In this example, the awards for this lottery ticket that are provided to the player are thus: (1) the $50 payout amount for the one pair card hand; (2) the $100 payout amount for the three of a kind card hand; and (3) the $500 payout amount for the four of a kind card hand. Thus, this example lottery ticket 100 is associated with at total award amount of $650. In this specific example, awards equal to the payout amounts of $200 and $1000 are not provided because the full house and royal flush card hands are not completed by the player cards.

It should be appreciated that in various embodiments, each lottery ticket can include and thus display additional information, such as a lottery ticket identification information (not shown) and/or any other relevant lottery ticket related information (not shown). It should also be appreciated that lottery ticket can be manufactured in various known manners or in new manners for producing physical or virtual lottery tickets. It should be appreciated that the shape, size, configuration, and quantity of spaces of the board can vary in accordance with the present disclosure. It should further be appreciated that the quantity of letters, player letters, words, shared letters, and unshared letters can vary in accordance with the present disclosure.

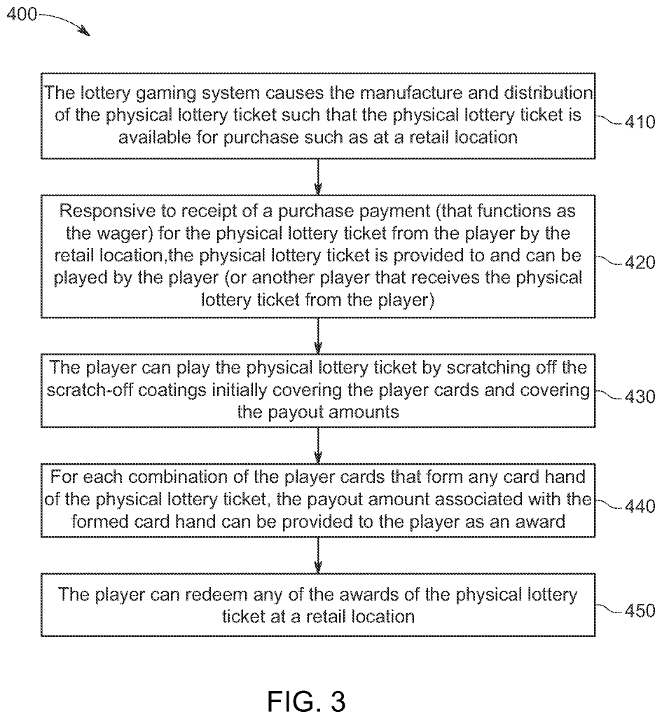

FIG. 3 is a flowchart of an example method 400 of providing an example lottery ticket of the present disclosure, where the lottery ticket is a physical lottery ticket. It should be appreciated that this method will vary if the lottery ticket is a virtual lottery ticket.

In the example method illustrated in FIG. 3, the lottery gaming system causes the manufacture and distribution of the physical lottery ticket such that the physical lottery ticket is available for purchase such as at a retail location, as indicated by block 410. The retail location can, for example, be a retail establishment that sells lottery tickets or can be an electronic lottery ticket provider such as lottery ticket kiosk, or otherwise as explained below.

Responsive to receipt of a purchase payment (that functions as the wager) for the physical lottery ticket from the player by the retail location, the physical lottery ticket is provided to and can be played by the player (or another player that receives the physical lottery ticket from the player), as indicated by block 420.

The player can play the physical lottery ticket by scratching off the scratch-off coatings initially covering the player cards and covering the payout amounts, as indicated by block 430. The player can do this in any suitable order for the player cards and the payout amounts.

For each combination of the player cards that form any card hand of the physical lottery ticket, the payout amount associated with the form card hand can be provided to the player as an award, as indicated by block 440.

In the example method illustrated in FIG. 3, the player can redeem any of the awards for the physical lottery ticket at a retail location (such as the retail establishment or lottery ticket kiosk that sold the player the lottery ticket or another suitable retail location), as indicated by block 450.

It should be appreciated from the above that various embodiments of the present disclosure provide a lottery ticket including: a base; a plurality of different symbol sets on the base, wherein each of the symbol sets include a plurality of different symbols; a plurality of different sequential ascending payout amounts on the base and respectively associated with the plurality of different symbol sets; a plurality of different player symbols on the base; a first removable cover on the base covering the plurality of player symbols; anda second removable cover on the base covering the plurality of different sequential ascending payout amounts. In various such embodiments, the plurality of different symbol sets include a plurality of different card hands, and the plurality of different player symbols include a plurality of different cards. In various such embodiments, the plurality of different card hands are of a plurality of different winning card hand categories. In various such embodiments, each of the plurality of different sequential ascending payout amounts is selected from one of a plurality of different payout amounts that can be associated with the respective different symbol sets that said payout amount is associated with. In various such embodiments, none of the plurality of different sequential ascending payout amounts are an actual awards for the lottery ticket based on the symbol sets and the player symbols of the lottery ticket. In various such embodiments, only one of the plurality of different sequential ascending payout amounts is an actual awards for the lottery ticket based on the symbol sets and the player symbols of the lottery ticket. In various such embodiments, each of a plurality but not all of the plurality of different sequential ascending payout amounts are actual awards for the lottery ticket based on the symbol sets and the player symbols of the lottery ticket. In various such embodiments, all of the plurality of different sequential ascending payout amounts are actual awards for the lottery ticket based on the symbol sets and the player symbols of the lottery ticket. In various such embodiments, the lottery ticket is a physical lottery ticket, wherein the base includes a substrate, the symbol sets are printed on the substrate, the player symbols are printed on the substrate, the first and second removable covers are scratch-off coatings covering the player symbols and the payout amounts. In various such embodiments, the lottery ticket is a virtual lottery ticket. It should be appreciated from the above that various other embodiments include a plurality of different sequential descending payout amounts instead of sequential ascending payout amounts.

It should further be appreciated from the above that various embodiments of the present disclosure provide a plurality of lottery tickets for a same lottery game. In various such embodiments, the plurality of lottery tickets include a first lottery ticket including: a base; a plurality of different symbol sets on the base, wherein each of the symbol sets include a plurality of different symbols; a plurality of different sequential ascending payout amounts on the base and respectively associated with the plurality of different symbol sets; a plurality of different player symbols on the base; a first removable cover on the base covering the plurality of player symbols; and a second removable cover on the base covering the plurality of different sequential ascending payout amounts. In various embodiments a second lottery ticket includes: a base; a plurality of different symbol sets on the base, wherein each of the symbol sets include a plurality of different symbols; a plurality of different sequential ascending payout amounts on the base and respectively associated with the plurality of different symbol sets on the base; a plurality of different player symbols on the base; a first removable cover on the base covering the plurality of player symbols; and a second removable cover on the base covering the plurality of different sequential ascending payout amounts. In various such embodiments, the plurality of different symbol sets of the first lottery ticket is the same as the plurality of different symbol sets of the second lottery ticket. In various such embodiments, the plurality of different sequential ascending payout amounts of the second lottery ticket are different than the different sequential ascending payout amounts of the first lottery ticket. In various such embodiments, each of the plurality of different symbol sets include a plurality of different card hands, and each of the plurality of different player symbols include a plurality of different cards. In various such embodiments, each of the plurality of different card hands for the first and second lottery ticket include a same set of winning categories of card hands. In various such embodiments, each of the plurality of different sequential ascending payout amounts for each of the first and second lottery tickets is selected from one of a plurality of different payout amounts that can be associated with the respective different symbol sets that said payout amount is associated with. In various such embodiments, each of the lottery tickets is a physical lottery ticket, wherein the base of each lottery ticket include a substrate, the symbol sets of each lottery ticket are printed on the substrate of that lottery ticket, the player symbols of each lottery ticket are printed on the substrate of that lottery ticket, the first and second removable covers of each lottery ticket are scratch-off coatings covering the player symbols and the payout amounts of that lottery ticket. In various such embodiments, each of the lottery tickets is a virtual lottery ticket. It should be appreciated from the above that various other embodiments include a plurality of different sequential descending payout amounts instead of sequential ascending payout amounts.

It should further be appreciated from the above that various embodiments of the present disclosure provide a system including a processor and a memory device that stores a plurality of instructions, that when executed by the processor, cause the processor to cause a plurality of lottery ticket to be created and provided to distributors or distribution systems. In various embodiments, at least a first lottery ticket includes: a base; a plurality of different symbol sets on the base, wherein each of the symbol sets include a plurality of different symbols; a plurality of different sequential ascending payout amounts on the base and respectively associated with the plurality of different symbol sets; a plurality of different player symbols on the base; a first removable cover on the base covering the plurality of player symbols; and a second removable cover on the base covering the plurality of different sequential ascending payout amounts. In various embodiments, at least a second lottery ticket includes: a base; a plurality of different symbol sets on the base, wherein each of the symbol sets include a plurality of different symbols; a plurality of different sequential ascending payout amounts on the base and respectively associated with the plurality of different symbol sets on the base; a plurality of different player symbols on the base; a first removable cover on the base covering the plurality of player symbols; and a second removable cover on the base covering the plurality of different sequential ascending payout amounts. In various such embodiments, the plurality of different symbol sets of the first lottery ticket is the same as the plurality of different symbol sets of the second lottery ticket. In various such embodiments, the plurality of different sequential ascending payout amounts of the second lottery ticket are different than the different sequential ascending payout amounts of the first lottery ticket. In various such embodiments, for each of the first and second lottery tickets, each of the plurality of different symbol sets include a plurality of different card hands, and each of the plurality of different player symbols include a plurality of different cards. In various such embodiments, each lottery ticket is a physical lottery ticket, wherein the base of each lottery ticket includes a substrate, the symbol sets of each lottery ticket are printed on the substrate of that lottery ticket, the player symbols of each lottery ticket are printed on the substrate of that lottery ticket, the first and second removable covers of each lottery ticket are scratch-off coatings covering the player symbols and the payout amounts of that lottery ticket. In various such embodiments, the lottery ticket is a virtual ticket. It should be appreciated from the above that various other embodiments include a plurality of different sequential descending payout amounts instead of sequential ascending payout amounts.

### Example Lottery Gaming Systems—General

In various embodiments of the present disclosure, the lottery gaming system and method are configured to be provided by a lottery agency (such as a state lottery agency). In various other embodiments of the present disclosure, the lottery gaming system and method are configured to be operated by a third party that runs the lottery for a lottery agency (such as a state lottery agency).

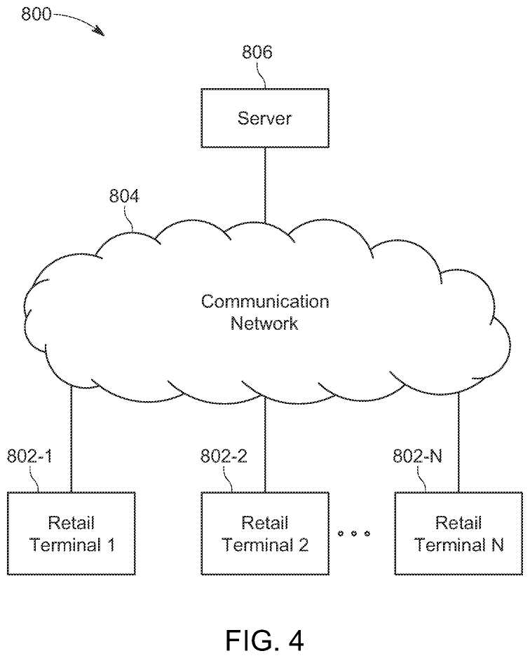

FIG. 4 illustrates an example networked lottery gaming system 800 for certain types of lottery ticket implementations. This example network lottery gaming system 800 generally includes: (1) a plurality of lottery retailer terminals 802-1 to 802-N; (2) a communications network 804; and (3) one or more lottery servers such as lottery server 806. Generally, the retailer terminals 802-1 to 802-N and the lottery server 806 are configured to perform certain functions described above and further described below.

In various embodiments of the lottery gaming systems and methods of the present disclosure, the player can purchase a respective physical or virtual lottery ticket via a suitable manner such as, but not limited to, one of the following: (1) a dedicated lottery kiosk (e.g., a lottery kiosk) configured to communicate over a data network (such as the Internet) to a lottery server (such as a lottery server 806 described below in connection with FIG. 4); (2) a retailer-operated lottery terminal configured to communicate over a data network (such as the Internet) to a lottery server (such as a lottery server 806 described below in connection with FIG. 4); (3) a personal computer configured to communicate over a data network (such as the Internet) to a lottery server (such as a lottery server 806 described below in connection with FIG. 4); (4) a personal mobile device (such as a cellular telephone, tablet, or PDA) configured to communicate over a data network (such as a wireless or cellular data network) to a lottery server (such as a lottery server 806 described below in connection with FIG. 4); or (5) for a physical lottery ticket, from a roll, pack, or book of such physical lottery tickets from a seller (such as a retailer) of such lottery tickets.

In the example embodiment of FIG. 4, each retailer terminal 802 corresponds to (or is associated with) a particular lottery retailer. For example, the first retailer terminal 802-1 of FIG. 4 can be associated with a first lottery retailer, such as a convenience store, and the second retailer terminal 802-2 of FIG. 4 can be associated with a second lottery retailer, such as a supermarket. It should be understood that any suitable quantity of lottery retailer terminals can be employed in the lottery gaming system 800, along with any suitable quantity of corresponding lottery servers 806.

In various example embodiments, the lottery retailer terminal 802 includes one or more processor(s). Generally, the processor is operative to perform or process instructions, and in particular, to operate in accordance with the various methods described herein. For example, the processor of the lottery retailer terminal 802 can be operable to enable the lottery retailer terminal 802 to transmit data to (and receive data from) the lottery server 806. More specifically, for physical lottery tickets, the processor can enable the transmission of data representing: (a) a physical lottery ticket pack (including a plurality of lottery tickets) for validation of the physical lottery tickets in that lottery ticket pack; and/or (b) each physical lottery ticket upon a player redeeming that physical lottery ticket at such lottery retailer. For virtual lottery tickets, the processor can enable the transmission of data representing: (a) each virtual lottery ticket for the sale of that virtual lottery ticket; and/or (b) each virtual lottery ticket upon a player redeeming that virtual lottery ticket at such lottery retailer.

In various example embodiments, the lottery retailer terminal 802 includes one or more input device(s). The input devices of the lottery retailer terminal 802 can include components such as an optical scanner and/or a barcode scanner, for reading and/or for deriving information associated with a lottery ticket. For example, a lottery ticket can include registration marks, authenticity data, various codes, micro-printed indicia, one or more sense marks, and/or other lottery indicia that must be read. Examples of additional input devices include, but are not limited to, a keypad, a mouse, an image capturing device (e.g., an optical character recognition (OCR) device), a biometric reader, a portable storage device (e.g., a memory stick), and the like.

In various example embodiments, the input device(s) of one or more of the lottery retailer terminals 802 can include a clock. The clock can be employed to detect, derive and/or append time and/or date information for use by the lottery server 806 to: (i) create a data record corresponding to lottery tickets purchased or redeemed at the lottery retailer terminal 802, (ii) to determine redemption time, round and/or date information associated with lottery tickets, and/or (iii) determine whether a lottery player has redeemed their lottery ticket in a manner that qualifies the player to receive a particular redemption or settlement amount.

In various example embodiments, one or more of the lottery retailer terminals 802 includes one or more output device(s). Such output device(s) can include such components as a display for outputting information to a lottery player or to a terminal operator (e.g., win/loss information and/or payout amounts), one or more benefit output devices (e.g., a cash drawer, a currency dispenser), a printer for producing a physical record (e.g., paper slip, receipt, ticket, voucher, coupon, etc.) that defines a lottery ticket, audio/video output device(s), and the like.

In various example embodiments, one or more of the lottery retailer terminals 802 also includes one or more communications port(s), such as a serial port, a modem or the like. Generally, the communications port of the lottery retailer terminal 802 can be operable to facilitate two-way data communications between (i) the lottery retailer terminal 802, and (ii) the lottery server 806. In accordance with some embodiments, the communications port of the lottery retailer terminal 802 can operate to facilitate the transmission of information between the lottery retailer terminal and a player device such as a personal digital assistant (PDA), cell phone and/or a dedicated (e.g., a proprietary) device.

In various example embodiments, one or more of the lottery retailer terminals 802 includes a data storage device such as a hard disk, optical or magnetic media, random access memory (RAM) and/or read-only memory (ROM), or the like memory device. Generally, the data storage device of the lottery retailer terminal 802 stores a software program, the software program enabling a processor of the retailer terminal 802 to perform various functions including some or all of the various steps described herein. For example, in accordance with certain embodiments, the lottery retailer terminal 802 can be configured to perform some or all of the functions of the lottery server 806 (and vice versa) such that the lottery server 806 and the lottery retailer terminal 802 can be considered as the same “device.”

In various example embodiments, a lottery ticket sales device can be utilized in place of a lottery retailer terminal 802. Such a lottery ticket sales device can be implemented as a lottery server, a controller, a dedicated hardware circuit, an appropriately programmed general-purpose computer, or any other equivalent electronic, mechanical, or electro-mechanical device. Thus, in various embodiments, a lottery ticket sales device can include, for example, but is not limited to: (1) a video lottery terminal that can include a touch sensitive screen for use by a player; (2) a personal computer (e.g., which communicates with a remote lottery server); or (3) a personal mobile device such as a mobile telephone, a tablet, or a personal digital assistant. The lottery ticket sales device can include any or all of the devices of the aforementioned systems.

In various example embodiments, the lottery server 806 operates to: (1) receive and/or store data associated with one or more lottery tickets including such data as: (a) ticket identifier(s), and (b) ticket indicia; (2) determine at least a first redemption amount associated with a lottery ticket; (3) receive a redemption request associated with the lottery ticket; (4) determine a time of play associated with the redemption request; and (5) transmit an indication of the appropriate redemption amount to a lottery retailer terminal (e.g., for output or display to a lottery player and/or lottery terminal operator).

In various example embodiments, the lottery server 806 includes one or more processor(s). Such a processor functions to process instructions, and in particular, to operate in accordance with various methods described herein. For example, the processor can operate to enable the lottery server 806 to transmit data to (and receive data from) the lottery retailer terminal 802. More specifically, the processor of the lottery server 806 can enable the transmission of data representing a lottery ticket, as well as information defining one or more payout(s) associated with that lottery ticket to or by a specific one of the lottery retailer terminals 802 shown in the lottery network 800 of FIG. 4. Thus, the lottery server 806 can be implemented as a system controller, a dedicated hardware circuit, an appropriately and particularly programmed general-purpose computer, or any other equivalent electronic, mechanical, or electro-mechanical device capable of providing for one or more of the embodiments described herein.

In various example embodiments, the lottery server 806 includes one or more input device(s). Examples of such input devices include a keypad, a mouse, a touchscreen, a random number generator, a microphone, and other digital or analog input devices.

In various example embodiments, the lottery server 806 also includes one or more output device(s). Example of output device(s) of the lottery server 806 include a monitor or other display for outputting information to an operator of the lottery server 806 (e.g., for displaying information such as statistical or sales data, win and loss information and/or payout amounts), a printer for producing a physical record (e.g., a report) of such data, and the like. In addition, the lottery server 806 can include one or more communications ports, such as a serial port, modem or the like, operable to facilitate two-way data communications between (i) the lottery server 806 and (ii) one or more lottery retailer terminals 802.

In various example embodiments, the lottery server 806 includes a data storage device (e.g., a hard disk or hard drive, a media-based (removable) memory, or the like). In certain embodiments, the data storage device of the lottery server 806 stores at least one software program, which includes a program to enable the processor of the lottery server 806 to perform some or all of the various steps and functions of at least one implementation of the methods described in detail herein. In addition, the data storage device of the lottery server 806 can operate to store one or more databases including a lottery ticket database and a lottery ticket redemption status database.

In various example embodiments, the lottery server 806 includes a lottery ticket server device that is located at a lottery ticket printing facility and can also function to manage the ticket printing process. The lottery server 806 can also function to develop a lottery game matrix (e.g., determining base payouts, win frequencies, and the like) and to match static lottery content with secure paytable (or payout distribution) data. In certain embodiments, a lottery ticket printer device for use in such lottery gaming systems can utilize the game matrix information from the lottery server and can apply it to the secure paytable data.

In certain example embodiments, a retailer terminal (such as the first retailer terminal 802-1) of FIG. 4 is configured to perform some or all of the functions of the lottery server 806. Thus, in certain example embodiments, the lottery server 806 and the retailer terminal (such as the first retailer terminal 802-1) (or another given retailer terminal and server pairing) can be considered as the same “device.”

Generally, the communications network 804 of FIG. 4 includes one or more local and/or wide-area network(s) proprietary and/or public network(s) (e.g., the Internet) for facilitating two-way data communications between the retailer terminals 802 and the lottery server 806. The lottery server 806 can communicate with lottery retailer terminals 802 directly or indirectly, via a wired or wireless medium, such as via the Internet, via a local area network (LAN), via a wide area network (WAN), via an Ethernet, via a Token Ring, via a telephone line, via a cable line, via a radio channel, via an optical communications line, via a satellite communications link, or via any other appropriate communications system or combinations thereof. Any number and type of devices can be in communication with the lottery server 806, and communication between the lottery retailer terminals 802 and the lottery server 806 can be direct or indirect. A variety of communications protocols can be part of any such communications system, including, but not limited to: Ethernet (or IEEE 802.3), SAP, ATP, Bluetooth™, and TCP/IP.

It should be understood that devices in communication with each other need not be continually transmitting to each other. On the contrary, such devices need only transmit to each other as necessary, and can actually refrain from exchanging data most of the time. For example, a device in communication with another device via the Internet may not transmit data to the other device for days or weeks at a time. In some embodiments, a server may not be necessary and/or preferred. For example, in one or more embodiments, methods described herein can be practiced on a stand-alone gaming device and/or a gaming device in communication only with one or more other gaming devices. In such an embodiment, any functions described as performed by the computer can instead be performed by one or more gaming devices.

As used herein, a lottery retailer can include a merchant who sells lottery tickets at a particular location, authenticates winning lottery tickets, redeems authenticated winning lottery tickets, and/or provides awards to players for winning lottery tickets. Examples of various lottery retailers include, but are not limited to, convenience stores, gas stations, supermarkets, and gaming establishments.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket comprising:
a base;
a plurality of different symbol sets on the base, wherein each of the symbol sets comprise a plurality of different symbols;
a plurality of different sequential ascending payout amounts on the base and respectively associated with the plurality of different symbol sets;
a plurality of different player symbols on the base;
a first removable cover on the base covering the plurality of player symbols; and
a second removable cover on the base covering the plurality of different sequential ascending payout amounts.

2. The lottery ticket of claim 1, wherein the plurality of different symbol sets comprise a plurality of different card hands, and the plurality of different player symbols comprise a plurality of different cards.

3. The lottery ticket of claim 2, wherein the plurality of different card hands are of a plurality of different winning card hand categories.

4. The lottery ticket of claim 1, wherein each of the plurality of different sequential ascending payout amounts is selected from one of a plurality of different payout amounts that can be associated with the respective different symbol sets that said payout amount is associated with.

5. The lottery ticket of claim 1, wherein none of the plurality of different sequential ascending payout amounts are an actual awards for the lottery ticket based on the symbol sets and the player symbols of the lottery ticket.

6. The lottery ticket of claim 1, wherein only one of the plurality of different sequential ascending payout amounts is an actual awards for the lottery ticket based on the symbol sets and the player symbols of the lottery ticket.

7. The lottery ticket of claim 1, wherein each of a plurality but not all of the plurality of different sequential ascending payout amounts are actual awards for the lottery ticket based on the symbol sets and the player symbols of the lottery ticket.

8. The lottery ticket of claim 1, wherein all of the plurality of different sequential ascending payout amounts are actual awards for the lottery ticket based on the symbol sets and the player symbols of the lottery ticket.

9. The lottery ticket of claim 1, which is a physical lottery ticket, wherein the base comprises a substrate, the symbol sets are printed on the substrate, the player symbols are printed on the substrate, the first and second removable covers are scratch-off coatings covering the player symbols and the payout amounts.

10. The lottery ticket of claim 1, which is a virtual lottery ticket.

11. A plurality of lottery tickets for a same lottery game, wherein the plurality of lottery tickets comprises:
a first lottery ticket comprising:
a base;
a plurality of different symbol sets on the base, wherein each of the symbol sets comprise a plurality of different symbols;
a plurality of different sequential ascending payout amounts on the base and respectively associated with the plurality of different symbol sets;
a plurality of different player symbols on the base;
a first removable cover on the base covering the plurality of player symbols; and
a second removable cover on the base covering the plurality of different sequential ascending payout amounts; and
a second lottery ticket comprising:
a base;
a plurality of different symbol sets on the base, wherein each of the symbol sets comprise a plurality of different symbols;
a plurality of different sequential ascending payout amounts on the base and respectively associated with the plurality of different symbol sets on the base;
a plurality of different player symbols on the base;
a first removable cover on the base covering the plurality of player symbols; and
a second removable cover on the base covering the plurality of different sequential ascending payout amounts,
wherein the plurality of different symbol sets of the first lottery ticket is the same as the plurality of different symbol sets of the second lottery ticket, and
wherein the plurality of different sequential ascending payout amounts of the second lottery ticket are different than the different sequential ascending payout amounts of the first lottery ticket.

12. The lottery ticket of claim 11, wherein each of the plurality of different symbol sets comprise a plurality of different card hands, and each of the plurality of different player symbols comprise a plurality of different cards.

13. The lottery ticket of claim 12, wherein each of the plurality of different card hands for the first and second lottery ticket comprise a same set of winning categories of card hands.

14. The lottery ticket of claim 11, wherein each of the plurality of different sequential ascending payout amounts for each of the first and second lottery tickets is selected from one of a plurality of different payout amounts that can be associated with the respective different symbol sets that said payout amount is associated with.

11. ottery tickets of claim 11, which are each a physical lottery ticket, wherein the base of each lottery ticket comprises a substrate, the symbol sets of each lottery ticket are printed on the substrate of that lottery ticket, the player symbols of each lottery ticket are printed on the substrate of that lottery ticket, the first and second removable covers of each lottery ticket are scratch-off coatings covering the player symbols and the payout amounts of that lottery ticket.

16. The lottery tickets of claim 11, which are each a virtual lottery ticket.

17. A system comprising:
a processor; and
a memory device that stores a plurality of instructions, that when executed by the processor, cause the processor to cause a plurality of lottery ticket to be created,
wherein a first lottery ticket comprises:
a base;
a plurality of different symbol sets on the base, wherein each of the symbol sets comprise a plurality of different symbols;
a plurality of different sequential ascending payout amounts on the base and respectively associated with the plurality of different symbol sets;
a plurality of different player symbols on the base;
a first removable cover on the base covering the plurality of player symbols; and
a second removable cover on the base covering the plurality of different sequential ascending payout amounts; and
wherein a second lottery ticket comprises:
a base;
a plurality of different symbol sets on the base, wherein each of the symbol sets comprise a plurality of different symbols;
a plurality of different sequential ascending payout amounts on the base and respectively associated with the plurality of different symbol sets on the base;
a plurality of different player symbols on the base;
a first removable cover on the base covering the plurality of player symbols; and
a second removable cover on the base covering the plurality of different sequential ascending payout amounts,
wherein the plurality of different symbol sets of the first lottery ticket is the same as the plurality of different symbol sets of the second lottery ticket, and
wherein the plurality of different sequential ascending payout amounts of the second lottery ticket are different than the different sequential ascending payout amounts of the first lottery ticket.

18. The system of claim 17, wherein for each of the first and second lottery tickets, each of the plurality of different symbol sets comprise a plurality of different card hands, and each of the plurality of different player symbols comprise a plurality of different cards.

19. The system of claim 17, wherein each lottery ticket is a physical lottery ticket, wherein the base of each lottery ticket comprises a substrate, the symbol sets of each lottery ticket are printed on the substrate of that lottery ticket, the player symbols of each lottery ticket are printed on the substrate of that lottery ticket, the first and second removable covers of each lottery ticket are scratch-off coatings covering the player symbols and the payout amounts of that lottery ticket.

20. The system of claim 17, wherein the lottery ticket is a virtual ticket.
